(19) United States
(12) Patent Application Publication
(10) Pub. No.: US 2011/0233965 A1
(43) Pub. Date: Sep. 29, 2011

(54) STRUCTURE THAT INCLUDES BOLT FASTENING PORTION HAVING HIGHER RESISTANCE AGAINST EXTERNAL FORCE

(75) Inventor: Yukio Oka, Aichi-ken (JP)

(73) Assignee: TOYOTA JIDOSHA KABUSHIKI KAISHA, Toyota-shi (JP)

(21) Appl. No.: 13/133,574

(22) PCT Filed: Dec. 7, 2009
(86) PCT No.: PCT/IB09/07657

§ 371 Date: Jun. 8, 2011

(30) Foreign Application Priority Data
Dec. 8, 2008 (JP) 2008-312655

(51) Int. Cl. B62D 25/24

(52) U.S. Cl. 296/193.02

(57) ABSTRACT

A structure (14) in which two structural members (18, 20) that each include thick portion and that have a plurality of bolt holes (26, 28, 30, 32) wherein the two structural members are overlapped at the thick portion and fastened together with bolts (42) at the plurality of bolt holes. In this structure, a certain amount of play is provided respectively for the bolts (42) at the bolt holes (26, 28, 30, 32) so that a shear force resulting from an external force applied to the structure (14) acting on the bolts (42) is even after at least one of the two structural members is deformed by the external force.

### BACKGROUND OF THE INVENTION

1. Field of the Invention

The present invention relates to a structure that has a higher-strength bolt fastening portion at which two structural members are bolted together.

2. Description of the Related Art

Japanese Patent No. 3936799 describes a cross member structure for a car body or other vehicle body, in which a cross member spans between side frames of the vehicle, and an output side portion of a transmission is supported on the vehicle body. In this structure, each end of the cross member is respectively attached to the side frames with three bolts through elongated bolt holes that are not aligned in a straight line. Upon a vehicle collision, this structure prevents the transmission and the engine from projecting toward a floor panel, while allowing the transmission and the engine to be displaced toward the rear. Further, Japanese Patent Application Publication No. 2005-212503 (JP-A-2005-212503) describes a car body lower part structure. In the described structure, a floor cross member extends in a vehicle width direction on a floor of the body, and front side members are disposed in a longitudinal direction of the body. The floor cross member is bolted to the front side members with a floor panel interposed between the floor cross member and the front side members.

There is a strong constraint on the car or vehicle body structure that the externally exposed body surface must provide an aesthetic appearance. Under this structural constraint, the car or vehicle body must be provided with a reinforcement member for an accidental collision on the inner side of the externally exposed surface. Therefore, an easy-assembly structure with high load-bearing performance is assembled to the body. In this structure, two structural members each include a thick portion that overlaps one another and that has a plurality of bolt holes, and the two structural members are connected together by fastening at the overlapping thick portions with bolts that respectively penetrate through the plurality of bolt holes. The bolted structure is employed for a floor cross member or a roof cross member of the car. The floor cross member traverses between the bottoms of the left and right side body frames. The roof cross member traverses between the tops of the left and right side body frames.

During normal vehicle operation, the load-bearing performance and the strength of the bolted portions of the described structure are provided by a friction force that is applied between the overlapping thick portions of the two structural members when the bolt is tightened. Under normal conditions a shear force does not act on the bolts. However, in the event that the vehicle encounters collision, an unexpectedly large external force is applied to the structure beyond its friction holding capability. This causes the overlapping thick portions of the two structural members to slide against each other. Thus, the structure receives the external force using a shear stress of the bolts. At this time, provided that the two structural members are fastened together at the overlapping thick portions with a plurality of bolts, there is a significant difference in load-bearing performance against the external force either when the plurality of bolts are either subjected to the shear force one by one in succession or all of the plurality of bolts are subjected to the shear force simultaneously.

### SUMMARY OF THE INVENTION

The present invention provides a structure of higher load-bearing performance against a large external force that is applied to the structure, in which two structural members that each include a thick portion that overlaps one another and that have a plurality of bolt holes, wherein the two structural members are overlapped at the thick portion and fastened together at the overlapping portions with bolts that respectively penetrate through the plurality of bolt holes.

One aspect of the invention is directed to a structure in which two structural members that each include a thick portion and that have a plurality of bolt holes, wherein the two structural members are overlapped at the thick portion and fastened together at the overlapping portions with bolts that respectively penetrate through the plurality of bolt holes. In this structure, a certain amount of play is provided respectively for the bolts at the bolt holes so that a shear force resulting from an external force applied to the structure acting on the bolts is even after at least one of the two structural members is deformed by the external force.

According to the aforementioned description, in the structure in which two structural members that each include a thick portion and that have a plurality of bolt holes, wherein the two structural members are fastened together at the overlapping portions with bolts that respectively penetrate through the plurality of bolt hole, a certain amount of play is provided respectively for the bolts at the bolt holes so that a shear force resulting from an external force applied to the structure acting on the bolts is even after at least one of the two structural members is deformed by the external force. There is a case where when the external force that is applied to the structure is so large that the overlapping thick portions of the two structural members, which are fastened together with the bolts and are brought into friction-engagement with each other, cannot bear the external force, then the overlapping thick portions slide each other, thus causing a shear force to acts on the bolts. In such a case, the above structure allows the shear force to act on all the plurality of bolts at the same time. This reduces the magnitude of the shear force that acts at a time on the individual bolts, and therefore enhances load-bearing performance of the bolt-fastening portion against the shear of the bolts.

The structure may be installed on a vehicle body, and upon a vehicle collision, the external force may be applied to the structure.

According to the aforementioned construction, the structure is installed on the vehicle body, and upon a vehicle collision, the external force is applied to the structure. This allows the vehicle body to have enhanced impact strength against an side impact to the vehicle.

The structure may be a floor cross member that is connected to a bottom part of left and right side frames of a car body, and the two structural members may be a center section of the floor cross member and a gusset that is connected to an end of the center section on one end of the floor cross member.

According to the aforementioned construction, the structure is a floor cross member that is connected to a bottom part of left and right side frames of a car body, and the two structural members are a center section of the floor cross member and a gusset that is connected to an end of the center section of the floor cross member. This enhances the effect of the floor cross member on reinforcing the impact strength of the body against the side impact at a bottom part of the body.

The structure may be a roof cross member that is connected to a top part of left and right side frames of a car body, and the two structural members may be a center section of the roof cross member and a gusset that is connected to an end of the center section of the roof cross member.

According to the aforementioned construction, the structure is a roof cross member that is connected to a top of left and right side frames of a car body, and the two structural members are a center section of the roof cross member and a gusset that is connected to an end of the center section of the roof cross member. This enhances the effect of the roof cross member on reinforcing the impact strength of the body against the side impact at a top part of the body.

The external force may be externally applied to the car body due to side collision of the vehicle, and a play margin in an external force-applied direction for the bolt at the bolt hole formed in a widthwise middle portion of at least one of the center section and the gusset may be larger than the play margin in the external force-applied direction for the bolts at the bolt holes formed on the sides of the center section and the gusset.

According to the aforementioned construction, the external force is externally applied to the car body due to side collision of the vehicle, and a play margin in an external force-applied direction for the bolt at the bolt hole formed in a widthwise middle portion of at least one of the center section and the gusset is larger than the play margin in the external force-applied direction for the bolts at the bolt holes formed on the sides of the center section and the gusset. Thus, in the structure in which the center section of the floor cross member and the roof cross member is attached on both sides to the side frames of the body via the gussets, when the vehicle receives a side impact, the center section and the gusset of the floor cross member and the roof cross member are compressed in their extending direction. At this time, the sides of the center section and the gusset tend to be more compressed in their extending direction than the widthwise middle portion. Particularly, this tendency is more remarkable for the center section, because the center section is longer than the gusset. As a result of such compression deformation, on the widthwise side parts, relative displacement between the bolt and the bolt hole is more lessened. In contrast, as a result of such compression deformation, on the widthwise middle portion, relative displacement between the bolt and the bolt hole is less lessened. Accordingly, a larger shear force acts on the bolt on the widthwise middle portion compared to the bolts on the sides of the center section and the gusset. In order to solve the problem of this larger shear force, the play margin in the external force-applied direction for the bolt at the bolt hole formed in the widthwise middle portion is larger than the play margin in the external force-applied direction for the bolts at the bolt holes formed on the sides of the center section and the gusset. This allows a uniform shear force to act on all the bolts.

In the above-mentioned construction, a difference in diameter between the bolt hole formed in the widthwise middle portion and the diameter of the bolt provided at the bolt hole formed in the widthwise middle portion may be larger than the difference in diameter between the bolt holes formed on the sides of the center section and gusset and the bolts provided at the bolt holes formed on the sides of the center section and gusset.

According to the aforementioned construction, a difference in diameter between the bolt hole formed in the widthwise middle portion and the diameter of the bolt provided at the bolt hole formed in the widthwise middle portion is larger than the difference in diameter between the bolt holes formed on the sides of the center section and the gusset and the bolts provided at the bolt holes formed on the sides of the center section and the gusset. Thus, a diameter of the bolt hole formed in the widthwise middle portion of at least one of the center section and the gusset and a diameter of the bolt holes formed in the sides of the center section and the gusset are determined as appropriate. This allows the play margin in the external force-applied direction for the bolt through the bolt hole that is formed on the widthwise middle portion of at least one of the center section and the gusset to be easily formed larger than the play margin in the external force-applied direction for the bolts through the bolt holes that are formed on the sides of the center section and the gusset.

In the above-mentioned construction, the bolt hole formed on the widthwise middle portion may be an elongated hole.

According to the aforementioned description, the play margin in the external force-applied direction for the bolt through the bolt hole that is formed on the widthwise middle portion of at least one of the center section and the gusset is formed larger than the play margin in the external force-applied direction for the bolts through the bolt holes that are formed on the widthwise side parts of the center section and the gusset by forming the bolt hole on the widthwise middle portion into a long hole. Thus, a part of the widthwise middle portion of at least one of the center section and the gusset, which is along one side of the bolt hole, is cut out in an arc shape. This allows the play margin in the external force-applied direction for the bolt through the bolt hole that is formed on the widthwise middle portion to be easily formed larger than the play margin in the external force-applied direction for the bolts through the bolt holes that are formed on the widthwise side parts.

The center section and the gusset may partly overlap one another at a concave portion with side edge ribs in a hat-shaped cross-section; on the overlapping portion of the center section and the gusset, the bolt holes may be formed respectively on a concave middle portion and on side edge rib of the concave portion with side edge ribs; and the play margin in the external force-applied direction for the bolt through the bolt hole that is formed on the concave middle part may be formed larger than the play margin in the external force-applied direction for the bolts through the bolt holes that are formed on the side edge ribs.

According to the aforementioned description, the center section and the gusset partly overlap one another at a concave portion with side edge ribs in a hat-shaped cross-section; on the overlapping portion of the center section and the gusset, the bolt holes are formed respectively on a concave middle part and on side edge ribs of the concave portion with side edge ribs; and the play margin in the external force-applied direction for the bolt at the bolt hole formed on the concave middle portion is formed larger than the play margin in the external force-applied direction for the bolts at the bolt holes formed on the side edge ribs. The floor cross member and the roof cross member are each formed of a concave member with side edge ribs. The concave member with side edge ribs has a high resistance against a compressive force that is applied to the floor cross member and the roof cross member in their extending direction. Therefore, the floor cross member and the roof cross member obtain enhanced impact strength at a bolt joint portion between the center section and the gusset.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1A and FIG. 1B are partial plan views of an example of a floor cross member of a car body, in which FIG. 1A shows an embodiment of a bolt joint portion of the floor cross member according to the invention, while FIG. 1B shows a partially modified example of the embodiment of the invention;

FIG. 2A and FIG. 2B are partial plan views of the floor cross member of FIG. 1A and FIG. 1B, each showing the deformation of bolt joint portion when a high compressive load is applied to the floor cross member as a result of a vehicle collision;

FIG. 3 is a perspective view of an example of the floor cross member and a roof cross member of the car body according to the invention, in which the floor cross member and the roof cross member are attached on one end to a side frame of the body; and

FIG. 4A and FIG. 4B are partial plan views of an example of a floor cross member of a car body, in which FIG. 4A shows another embodiment of a bolt joint portion of the floor cross member according to the invention, while FIG. 4B shows a partially modified example of the another embodiment of the invention.

### DETAILED DESCRIPTION OF EMBODIMENTS

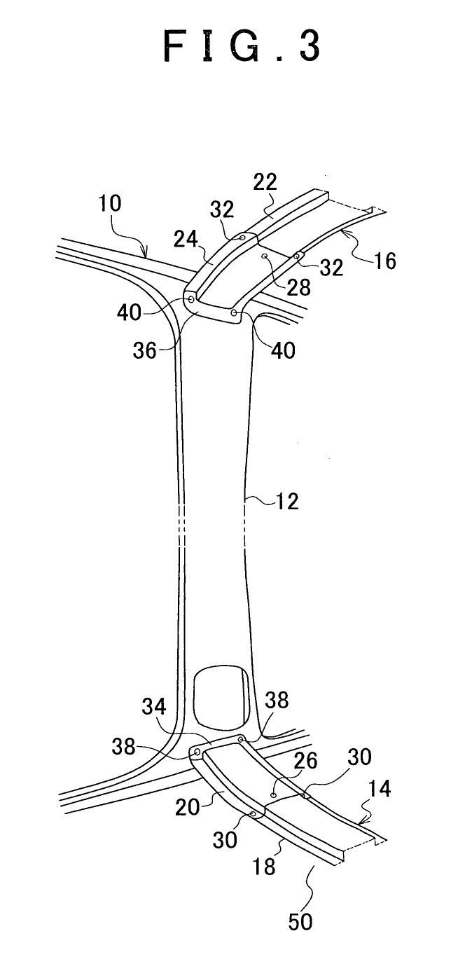

FIG. 3 is a perspective view of an example of a floor cross member and a roof cross member of a car body according to the invention, in which the floor cross member and the roof cross member are attached at one end to a side frame of the body. As shown in FIG. 3, the car body includes a side frame 10, a pair of center pillars 12, a floor cross member 14, and a roof cross member 16. The center pillars 12 are provided individually on the left and right sides of the vehicle. Each end of the floor cross member 14 is respectively attached to the lower ends of the left and right center pillars 12 (FIG. 3 only shows one of the center pillars). Likewise, each end of the roof cross member 16 is respectively attached to the upper ends of the left and right center pillars 12.

The floor cross member 14 includes: a central section 18 that forms a central part of the floor cross member 14; and gussets 20 that are attached to each end of the floor cross member 14. FIG. 3 shows only one of the gussets 20 attached on the ends of the floor cross member 14. As in the case of the floor cross member 14, the roof cross member 16 includes: a central section 22 that forms a central part of the roof cross member 16; and gussets 24 that are attached to each end of the roof cross member 16. FIG. 3 shows only one of the gussets 24 attached on the ends of the roof cross member 16. The floor cross member 14 and the roof cross member 16 are both formed in a concave structure with side edge ribs in a hat-shaped cross-section. Therefore, the center section 18 and the gussets 20 of the floor cross member 14 and the center section 22 and the gussets 24 of the roof cross member 16 are all a concave member with side edge ribs in a hat-shaped cross section. The center section and the gusset or the concave members with side edge ribs individually have a thick portion on one end. The thick portions of the center section and the gusset overlap one another. A bolt hole 26 or 28 is formed on a concave middle portion and bolt holes 30 or 32 that are formed on the side edge ribs of the overlapping thick portions. The center section and the gusset are fastened together at the overlapping thick portions with bolts that penetrate through the bolt holes 26, 30 or 28, 32, thus forming the floor cross member 14 or the roof cross member 16. However, none of these bolts are shown in FIG. 3 for the sake of convenience. The bolts may be ordinary bolts that have a head at one end. The center section and the gusset are fastened together at the overlapping thick portions with the bolts and ordinary nuts. The bolts through the bolt holes 26, 28, 30, 32 are tightened with each ordinary nut onto the other end of the bolt.

In FIG. 3, one end of each of the gusset 20 of the floor cross member 14 and the gusset 24 of the roof cross member 16 contacts the center pillar 12 of the side frame. The respective contact ends of the gussets 20, 24 are provided with flanges 34, 36. The flange 34 overlaps with a lower end of the center pillar 12, while the flange 36 overlaps with an upper end of the center pillar 12. Bolt holes 38, 40 are formed on these overlapping portions. The contact ends of the gussets 20, 24 are attached to the center pillar 12 at the flanges 34, 36 with bolts that penetrate through the bolt holes 38, 40. Again, none of these bolts are shown in FIG. 3 for the sake of convenience.

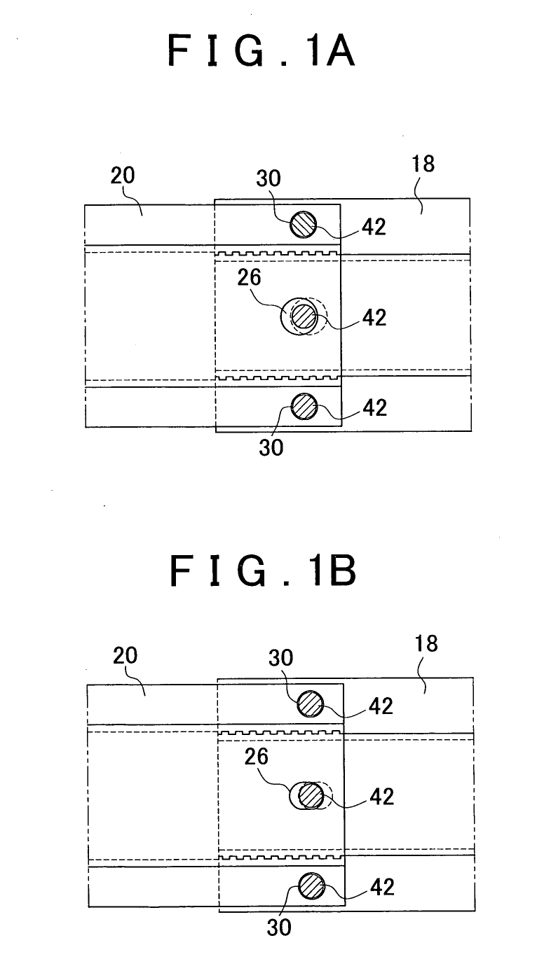

FIG. 1A and FIG. 1B are partial plan views of an example of the overlapping thick portion of the center section 18 and the gusset 20 of the floor cross member 14 in FIG. 3, showing variations on the structure of the bolt holes 26, 30 that are formed on the floor cross member 14. In FIG. 1A and FIG. 1B, the shank of each bolt 42 is shown in cross section. In addition, in FIG. 1A and FIG. 1B, the bolts 42 through the bolt holes 26, 30 all have an identical diameter.

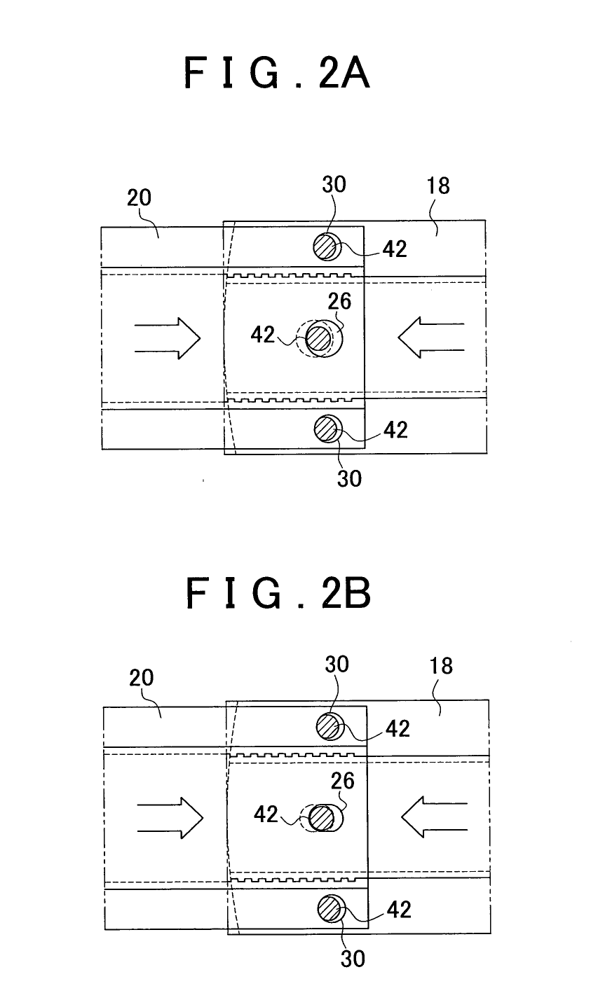

As shown in FIG. 1A and FIG. 1B, the bolt holes 30 are formed on the edge ribs and are the same diameter as the bolts 42 that penetrate through the bolt holes 30. In addition, according to the embodiment in FIG. 1A, the bolt hole 26 is formed in the concave middle portion of the gusset 20 and has a diameter larger than that of the bolt 42, while the diameter of the bolt hole 26 formed on the center section 18 is equal to that of the bolt 42. Further, the diameter of the bolt hole 26 is larger than that of the bolt holes 30. As shown in FIG. 1A, the bolt 42 to be tightened is located off-center in the bolt hole 26 formed on the gusset 20. How much larger the diameter of the bolt hole 26 is than that of the bolt 42 will be discussed later with reference to FIG. 2A and FIG. 2B. Alternatively, the bolt hole 26 on the center section 18 may have a larger diameter than that of the bolt 42, while the diameter of the bolt hole 26 on the gusset 20 may be the same as that of the bolt 42. In this case, the bolt hole on the center section 18 is located as shown by a dotted line in FIG. 1A. Further alternatively, the diameters of both the bolt hole 26 on the gusset 20 and the bolt hole on the center section 18 may be larger than that of the bolt 42.

In turn, according to the embodiment in FIG. 1B, the bolt hole 26 is formed on the concave middle portion of the gusset 20 into a long hole that extends in a longitudinal direction as shown in FIG. 1B, while the width of the bolt hole formed on the center section 18 is the same as the diameter of the bolt 42. The width of the long hole may correspond to the bolt diameter. As shown in FIG. 1B, the bolt 42 to be tightened in the bolt hole 26 of the gusset 20 is also located off-center. How much longer the bolt hole 26 is formed in the longitudinal direction than the diameter of the bolt 42 will be discussed later with reference to FIG. 2A and FIG. 2B. Alternatively, the bolt hole on the center section 18 may instead be elongated, while the bolt hole 26 on the gusset 20 may be the same diameter as the bolt 42. In this case, the elongated bolt hole 26 on the center section 18 is located as shown by a dotted line in FIG. 1B. Further alternatively, the bolt hole in both the gusset 20 and the center section 18 may be elongated relative to the diameter of the bolt.

FIG. 2A and FIG. 2B show the deformation of the joint portion of the center section 18 and the gusset 20 when an impact force due to side collision of the vehicle or the like is applied to the floor cross member 14 of FIG. 1A and FIG. 1B in a longitudinal direction of the floor cross member 14. As a compressive force is applied to the floor cross member 14 in its longitudinal direction, the center section 18 and the gusset 20 are both compressed in the longitudinal direction, accordingly. The edges of the center section 18 and the gusset 20 tend to be compressed more than the middle portion. Particularly because the center section 18 and the gusset 20 are formed in a hat-shaped cross-section having concave middle portion with ribs on edges, the compression stiffness of the middle portion of the center section 18 and the gusset 20 is greater than the compression stiffness of the edges of the center section 18 and the gusset 20. This creates a significant difference in degree of compression between the middle portion and the edges. In the illustrated example, the center section 18 is longer than the gusset 20. Accordingly, at the joint between the gusset 20 and the center section 18, the difference in degree of compression between the edge and the middle portion of the center section 18 is greater than that of the gusset 20. FIG. 2A and FIG. 2B show the deformation of the center section 18 at one end due to the different compression stiffness between the middle portion and the edges in an exaggerated manner.

As described above, at the joint ends of the center section 18 and the gusset 20, there is a difference in degree of compression between the edges and the middle portion. This causes relative displacement in the longitudinal direction of the floor cross member 14 between the bolt hole 26 on the middle portion and the bolt holes 30 on the edges. In this case, if the diameter of the bolt holes 26, 30 are the same as that of the bolts 42, the bolt 42 fastening the middle portion of the gusset 20 to the middle portion of the center section 18 is subjected to a shear force that is significantly higher than the shear force on the other bolts 42 fastening the edges of the gusset 20 and the edges of the center section 18 to each other. Consequently, strength of the middle bolt 42 against the shear force should be increased.

In contrast, if at least one of the bolt holes 26 of the middle portion of the gusset 20 and the center section 18 has a larger diameter or is longer than the diameter of the bolt 42, the middle bolt 42 and the side-edge bolts 42 are all subjected to a shear force at the same time when a given impact compressive load is applied, as shown in FIG. 2A and FIG. 2B. This maximizes the load-bearing performance of the floor cross member 14 and the roof cross member 16 against the impact compressive load.

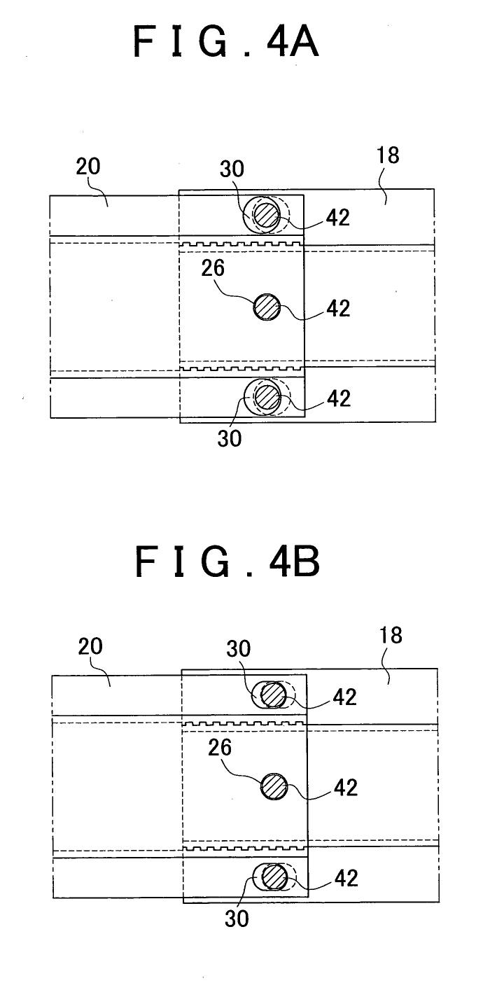

In the above embodiment, the bolt hole 26 formed in at least one of the middle portion of the gusset 20 or the center section 18 may have a larger diameter or elongated with respect to the diameter of the bolt 42. The present invention is not limited to this. As shown in FIG. 4A, the bolt holes 26 in the middle portion of the gusset 20 and the center section 18 may have the same diameter as the bolt 42, while the bolt holes 30 on the edges of the gusset 20 or the center section 18 may have a diameter that is appropriately larger than that of the bolts 42. Alternatively, as shown in FIG. 4B, the bolt holes 30 on the edges of the gusset 20 or the center section 18 may be elongated relative to the diameter of the bolts 42. As described above, at one longitudinal end of the gusset 20, the edges are provided with bolt holes 30 that are either larger or longer than the diameter of the bolts 42. In the case where the edges of the center section 18 are welded to the floor panel 50, a stress concentration on the portions of the edges of the center section 18 that are welded to the floor panel 50 is reduced.

Although one embodiment of the invention and partially modified examples of the embodiment are described above in detail, it should be apparent to those skilled in the art that various changes and modifications may be made to the embodiments within the scope of the invention.

1-13. (canceled)

14. A structure comprising:
two structural members that each include a thick portion having a plurality of bolt holes; and
bolts that respectively penetrate through the plurality of bolt holes,
wherein the two structural members each include an overlapping portion which is overlapped at the thick portion and the two structural members are fastened together at the overlapping portions with the bolts, and
wherein a certain amount of play is provided respectively for the bolts at the bolt holes so that a shear force resulting from an external force applied to the structure acting on the bolts is even at the same time after at least one of the two structural members is deformed by the external force.

15. The structure according to claim 14, wherein:
the structure is installed on a vehicle body; and
upon a vehicle collision, the external force is applied to the structure.

16. The structure according to claim 15, wherein:
the structure is a floor cross member that is connected to a bottom part of left and right side frames of a car body; and
the two structural members are a center section of the floor cross member and a gusset that is connected to an end of the center section of the floor cross member.

17. The structure according to claim 15, wherein:
the structure is a roof cross member that is connected to a top part of left and right side frames of a car body; and
the two structural members are a center section of the roof cross member and a gusset that is connected to an end of the center section of the roof cross member.

18. The structure according to claim 16, wherein:
the external force is externally applied to the car body due to side collision of the vehicle; and
a play margin in an external force-applied direction for the bolt at the bolt hole formed in a widthwise middle portion of at least one of the center section and the gusset is larger than the play margin in the external force-applied direction for the bolts at the bolt holes formed on the sides of the center section and the gusset.

19. The structure according to claim 18, wherein a difference in diameter between the bolt hole formed in the widthwise middle portion and the bolt provided at the bolt hole formed in the widthwise middle portion is larger than the difference in diameter between the bolt holes formed on the sides of the center section and the gusset and the bolts provided at the bolt holes formed on the sides of the center section and the gusset.

20. The structure according to claim 18, wherein the bolt hole formed on the widthwise middle portion is an elongated hole.

21. The structure according to claims 18, wherein:
the center section and the gusset are formed with a hat-shaped cross-section, in which a concave portion is formed at the widthwise middle portion and side ribs are formed along the sides of the center section and the gusset, and are partly overlapped at the concave portion and the side ribs of the hat-shaped cross-section;
the bolt holes are respectively formed in a middle portion of the concave portion and the side ribs where the center section and the gusset overlap; and
the play margin in the external force-applied direction for the bolt at the bolt hole that is formed on the middle portion of the concave portion is larger than the play margin in the external force-applied direction for the bolts at the bolt holes that are formed on the side ribs.

22. The structure according to claim 16, wherein:
the external force is externally applied to the car body due to side collision of the vehicle; and
a play margin in the external force-applied direction for the bolts at the bolt holes formed on the sides of at least one of the center section and the gusset is larger than the play margin in an external force-applied direction for the bolt at the bolt holes formed in a widthwise middle portion of at least one of the center section and the gusset.

23. The structure according to claim 22, wherein a difference in diameter between the bolt holes formed on the sides of the center section and the gusset and the bolts provided at the bolt holes formed on the sides of the center section and the gusset is larger than the difference in diameter between the bolt hole formed in the widthwise middle portion and the bolt provided at the bolt hole formed in the widthwise middle portion.

24. The structure according to claim 22, wherein the bolt holes formed on the sides of at least one of the center section and the gusset are elongated holes.

25. The structure according to claim 22, wherein:
the center section and the gusset are formed with a hat-shaped cross-section, in which a concave portion is formed at the widthwise middle portion and side ribs are formed along the sides of the center section and the gusset, and are partly overlapped at the concave portion and the side ribs of the hat-shaped cross-section,
the bolt holes are respectively formed in a middle portion of the concave portion and the side ribs where the center section and the gusset overlap; and
the play margin in the external force-applied direction for the bolts at the bolt holes that are formed on the side ribs is larger than the play margin in the external force-applied direction for the bolt at the bolt hole that is formed on the middle portion of the concave portion.

26. A structure comprising:
bolts; and
structural members that are bolted together with the bolts,
wherein a different amount of play is provided in a bolt hole for each of the bolts.
